(19) United States
(12) Patent Application Publication
(10) Pub. No.: US 2024/0073991 A1
(43) Pub. Date: Feb. 29, 2024

(54) CONTROLLING ACTIVE TIME OF A TERMINAL DEVICE

(71) Applicant: Telefonaktiebolaget LM Ericsson (PUBL), Stockholm (SE)

(72) Inventors: Min Wang, LULEÅ (SE); Zhang Zhang, BEIJING (CN)

(21) Appl. No.: 18/261,218

(22) PCT Filed: Jan. 14, 2022
(86) PCT No.: PCT/IB2022/050297

§ 371 Date: Jul. 12, 2023

(30) Foreign Application Priority Data
Jan. 14, 2021 (WO) PCT/CN2021/071955

(51) Int. Cl. H04W 76/28; H04L 5/00

(52) U.S. Cl. CPC H04W 76/28; H04L 5/0053; H04W 92/18

(57) ABSTRACT

The present disclosure provides a method implemented by a first terminal device. The method includes the step of transmitting, over a sidelink, to a second terminal device, a first message for controlling discontinuous reception (DRX) status of the second terminal device.

The corresponding apparatus, system, device, computer-readable storage and carrier, etc. thereof are also provided.

### TECHNICAL FIELD

Embodiments of the present disclosure are directed to wireless communications and, more particularly, to controlling discontinuous receptions (DRX) status of a terminal device.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

This section is intended to provide a background for the various embodiments of the technology described in this disclosure. The description in this section may include concepts that could be pursued but are not necessarily ones that have been previously conceived or pursued. Therefore, unless otherwise indicated herein, what is described in this section is not prior art to the description and/or claims of this disclosure and is not admitted to be prior art by the mere inclusion in this section.

According to Third Generation Partnership Project (3GPP), for example clause 5.7 of TS 38.321 V 16.3.0, the medium access control (MAC) entity may be configured by radio resource control (RRC) with a discontinuous reception (DRX) functionality that controls a user equipment (UE) physical downlink control channel (PDCCH) monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. When using DRX operation, the MAC entity shall also monitor PDCCH according to requirements found in other clauses of the specification. When in RRC_CONNECTED, if DRX is configured, for all the activated Serving Cells, the MAC entity may monitor the PDCCH discontinuously using the DRX operation specified in clause 5.7; otherwise the MAC entity shall monitor the PDCCH as specified in TS 38.213.

Sidelink transmissions over new radio (NR) are specified in 3GPP Rel. 16. These are enhancements of the ProSe (PROximity-based SErvices) specified for long term evolution (LTE).

### SUMMARY

Based on the description above, certain challenges currently exist with controlling the discontinuous reception (DRX) status of a terminal device. Certain aspects of the present disclosure and their embodiments may provide solutions to these or other challenges.

According to a first aspect of the disclosure, there is provided a method implemented by a first terminal device. The method includes the step of transmitting, over a sidelink, to a second terminal device, a first message for controlling DRX status of the second terminal device.

According to a second aspect of the disclosure, there is provided a method implemented by a second terminal device. The method includes the step of receiving, over a sidelink, from a first terminal device, a first message for controlling DRX status of the second terminal device.

According to a third aspect of the disclosure, there is provided a method implemented by a control node. The method includes the step of transmitting, to a first terminal device, a second message for controlling DRX status of the first terminal device and/or both the first terminal device and the second terminal device.

According to a fourth aspect of the disclosure, there is provided an apparatus for a first terminal device. The apparatus includes a transmitting component, configured to transmit, over a sidelink, to a second terminal device, a first message for controlling DRX status of the second terminal device.

According to a fifth aspect of the disclosure, there is provided an apparatus for a second terminal device. The apparatus includes a receiving component, configured to receive, over a sidelink, from a first terminal device, a first message for controlling DRX status of the second terminal device.

According to a sixth aspect of the disclosure, there is provided an apparatus for a control node. The apparatus includes a transmitting component, configured to transmit, to a first terminal device, a second message for controlling DRX status of the first terminal device and/or both the first terminal device and the second terminal device.

According to a seventh aspect of the disclosure, there is provided a communication device in a communication network, the communication device includes a storage, adapted to store instructions therein; a processor, adapted to execute the instructions to cause the communication device to perform the method of any of any of the methods herein.

According to a eighth aspect of the disclosure, there is provided a communication system. The communication system includes a first terminal device of the first aspect, a second terminal device of the second aspect, and a control node of the third aspect, wherein the first terminal device communicates with the control node and the second terminal device.

According to a nineth aspect of the disclosure, there is provided a computer-readable storage. The computer-readable storage stores computer-executable instructions thereon, when executed by a computing device, causing the computing device to implement the method of any of any of the methods herein.

According to a tenth aspect of the disclosure, there is provided a computer program product. The computer program product comprises instructions which, when executed on at least one processor, cause the at least one processor to carry out the method according to any one of the methods herein.

According to a eleventh aspect of the disclosure, there is provided a carrier containing the computer program of the tenth embodiment, wherein the carrier is one of an electronic signal, optical signal, radio signal, or computer readable storage.

According to a twelfth aspect of the disclosure, there is provided an apparatus adapted to perform the method according to any one of the methods herein.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and details through use of the accompanying drawings.

FIG. 1a illustrates an example procedure for DRX configurations according to embodiments of the present disclosure.

FIG. 1b illustrates an example procedure for DRX configurations according to embodiments of the present disclosure.

FIG. 2a illustrates an example procedure for DRX configurations according to embodiments of the present disclosure.

FIG. 2b illustrates an example procedure for DRX configurations according to embodiments of the present disclosure.

FIG. 3 illustrates a flow chart for a first terminal device according to embodiments of the present disclosure.

FIG. 4 illustrates a flow chart for a second terminal device according to embodiments of the present disclosure.

FIG. 5 illustrates a flow chart for a control node according to embodiments of the present disclosure.

FIG. 6a illustrates a schematic block diagram of a first terminal device according to embodiments of the present disclosure.

FIG. 6b illustrates a schematic block diagram of a second terminal device according to embodiments of the present disclosure.

FIG. 6c illustrates a schematic block diagram of a control node according to embodiments of the present disclosure.

FIG. 6d is a block diagram illustrating a wireless communication system according to some embodiments of the present disclosure.

FIG. 7 schematically illustrates an embodiment of an arrangement which may be used for anomaly detection according to embodiments of the present disclosure.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10-13 are flowcharts illustrating methods implemented in a communication system including a host computer, a base station and a user equipment.

### DETAILED DESCRIPTION

As described above, certain challenges currently exist with controlling the discontinuous reception (DRX) status of a terminal device. Certain aspects of the present disclosure and their embodiments may provide solutions to these or other challenges.

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first request and a second request indicate different requests regardless of the order or importance.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a storage device.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein, for example, concepts of DRX, sidelink (SL), medium access control (MAC) control element (CE), etc. are generally understood in the context of Third Generation Partnership Project (3GPP). Though many embodiments herein are described in the context of Next Generation network (such as fifth generation (5G) communication networks), other networks may also be applicable.

If sidelink resource allocation mode 1 is configured by radio resource control (RRC), a DRX functionality is not configured.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the physical downlink control channel (PDCCH) occasion in which a PDCCH indicates a new uplink or downlink transmission for the MAC entity;
drx-RetransmissionTimerDL (per downlink hybrid automatic repeat request (HARQ) process except for the broadcast process): the maximum duration until a downlink retransmission is received;
drx-RetransmissionTimerUL (per uplink HARQ process): the maximum duration until a grant for uplink retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per downlink HARQ process except for the broadcast process): the minimum duration before a downlink assignment for HARQ retransmission is expected by the MAC entity;
drx-HARQ-RTT-TimerUL (per uplink HARQ process): the minimum duration before an uplink HARQ retransmission grant is expected by the MAC entity;
ps-Wakeup (optional): the configuration to start associated drx-onDurationTimer in case DCP is monitored but not detected;
ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
ps-TransmitPeriodicL1-RSRP (optional): the configuration to transmit periodic channel state information (CSI) that is L1-RSRP on PUCCH during the time duration indicated by drx-onDurationTimer in case DCP is configured but associated drx-onDurationTimer is not started.

Serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups.

The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL

When a DRX cycle is configured, the active time for serving cells in a DRX group includes the time while:
drx-onDurationTimer or drx-InactivityTimer configured for the DRX group is running; or
drx-RetransmissionTimerDL or drx-RetransmissionTimerUL is running on any serving cell in the DRX group; or
ra-ContentionResolutionTimer (as described in clause 5.1.5 of TS 38.321 V 16.3.0) or msgB-ResponseWindow (as described in clause 5.1.4a of TS 38.321 V 16.3.0) is running; or
a Scheduling Request is sent on PUCCH and is pending (as described in clause 5.4.4 of TS 38.321 V 16.3.0); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a of TS 38.321 V 16.3.0).

When DRX is configured, the MAC entity shall:
1> if a MAC PDU is received in a configured downlink assignment:
2> start the drx-HARQ-RTT-TimerDL for the corresponding HARQ process in the first symbol after the end of the corresponding transmission carrying the downlink HARQ feedback;
2> stop the drx-RetransmissionTimerDL for the corresponding HARQ process.
1> if a MAC PDU is transmitted in a configured uplink grant and LBT failure indication is not received from lower layers:
2> start the drx-HARQ-RTT-TimerUL for the corresponding HARQ process in the first symbol after the end of the first transmission (within a bundle) of the corresponding PUSCH transmission;
2> stop the drx-RetransmissionTimerUL for the corresponding HARQ process at the first transmission (within a bundle) of the corresponding PUSCH transmission.
1> if a drx-HARQ-RTT-TimerDL expires:
2> if the data of the corresponding HARQ process was not successfully decoded:
3> start the drx-RetransmissionTimerDL for the corresponding HARQ process in the first symbol after the expiry of drx-HARQ-RTT-TimerDL.
1> if a drx-HARQ-RTT-TimerUL expires:
2> start the drx-RetransmissionTimerUL for the corresponding HARQ process in the first symbol after the expiry of drx-HARQ-RTT-TimerUL.
1> if a DRX Command MAC CE or a Long DRX Command MAC CE is received:
2> stop drx-onDurationTimer for each DRX group;
2> stop drx-InactivityTimer for each DRX group.
1> if drx-InactivityTimer for a DRX group expires:
2> if the Short DRX cycle is configured:
3> start or restart drx-ShortCycleTimer for this DRX group in the first symbol after the expiry of drx-InactivityTimer;
3> use the Short DRX cycle for this DRX group.
2> else:
3> use the Long DRX cycle for this DRX group.
1> if a DRX Command MAC CE is received:
2> if the Short DRX cycle is configured:
3> start or restart drx-ShortCycleTimer for each DRX group in the first symbol after the end of DRX Command MAC CE reception;
3> use the Short DRX cycle for each DRX group.
2> else:
3> use the Long DRX cycle for each DRX group.
1> if drx-ShortCycleTimer for a DRX group expires:
2> use the Long DRX cycle for this DRX group.
1> if a Long DRX Command MAC CE is received:
2> stop drx-ShortCycleTimer for each DRX group;
2> use the Long DRX cycle for each DRX group.
1> if the Short DRX cycle is used for a DRX group, and [(SFN×10)+subframe number] modulo (drx-ShortCycle)=(drx-StartOffset) modulo (drx-ShortCycle):
2> start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
2> if DCP monitoring is configured for the active DL BWP as specified in TS 38.213, clause 10.3:
3> if DCP indication associated with the current DRX cycle received from lower layer indicated to start drx-onDurationTimer, as specified in TS 38.213; or
3> if all DCP occasion(s) in time domain, as specified in TS 38.213, associated with the current DRX cycle occurred in active time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-ResponseWindow is running (as specified in clause 5.1.4 of TS 38.321 V 16.3.0); or
3> if ps-Wakeup is configured with value true and DCP indication associated with the current DRX cycle has not been received from lower layers:
4> start drx-onDurationTimer after drx-SlotOffset from the beginning of the subframe.
2> else:
3> start drx-onDurationTimer for this DRX group after drx-SlotOffset from the beginning of the subframe.

NOTE 2: In case of unaligned SFN across carriers in a cell group, the SFN of the SpCell is used to calculate the DRX duration.
1> if a DRX group is in active time:
2> monitor the PDCCH on the Serving Cells in this DRX group as specified in TS 38.213;
2> if the PDCCH indicates a downlink transmission:
3> start the drx-HARQ-RTT-TimerDL for the corresponding HARQ process in the first symbol after the end of the corresponding transmission carrying the downlink HARQ feedback;

NOTE 3: When HARQ feedback is postponed by PDSCH-to-HARQ_feedback timing indicating a non-numerical kl value, as specified in TS 38.213, the corresponding transmission opportunity to send the downlink HARQ feedback is indicated in a later PDCCH requesting the HARQ-ACK feedback.
3> stop the drx-RetransmissionTimerDL for the corresponding HARQ process.
3> if the PDSCH-to-HARQ_feedback timing indicate a non-numerical kl value as specified in TS 38.213:
4> start the drx-RetransmissionTimerDL in the first symbol after the PDSCH transmission for the corresponding HARQ process.
2> if the PDCCH indicates an uplink transmission:
3> start the drx-HARQ-RTT-TimerUL for the corresponding HARQ process in the first symbol after the end of the first transmission (within a bundle) of the corresponding PUSCH transmission;
3> stop the drx-RetransmissionTimerUL for the corresponding HARQ process.
2> if the PDCCH indicates a new transmission (downlink or uplink) on a serving cell in this DRX group:
3> start or restart drx-InactivityTimer for this DRX group in the first symbol after the end of the PDCCH reception.
2> if a HARQ process receives downlink feedback information and acknowledgement is indicated:
3> stop the drx-RetransmissionTimerUL for the corresponding HARQ process.
1> if DCP monitoring is configured for the active downlink bandwidth part (BWP) as specified in TS 38.213, clause 10.3; and
1> if the current symbol n occurs within drx-onDurationTimer duration; and
1> if drx-onDurationTimer associated with the current DRX cycle is not started as specified in this clause:
2> if the MAC entity would not be in active time considering grants/assignments/DRX Command MAC CE/Long DRX Command MAC CE received and Scheduling Request sent until 4 ms prior to symbol n when evaluating all DRX active time conditions as specified in this clause:
3> not transmit periodic SRS and semi-persistent SRS defined in TS 38.214;
3> not report semi-persistent CSI configured on PUSCH;
3> if ps-TransmitPeriodicL1-RSRP is not configured with value true:
4> not report periodic CSI that is L1-RSRP on PUCCH.
3> if ps-TransmitOtherPeriodicCSI is not configured with value true:
4> not report periodic CSI that is not L1-RSRP on PUCCH.
1> else:
2> in current symbol n, if a DRX group would not be in active time considering grants/assignments scheduled on serving cell(s) in this DRX group and DRX Command MAC CE/Long DRX Command MAC CE received and Scheduling Request sent until 4 ms prior to symbol n when evaluating all DRX active time conditions as specified in this clause:
3> not transmit periodic SRS and semi-persistent SRS defined in TS 38.214 in this DRX group;
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
4> not report CSI on PUCCH in this DRX group.

NOTE 4: If a UE multiplexes a CSI configured on PUCCH with other overlapping UCI(s) according to the procedure specified in TS 38.213 clause 9.2.5 and this CSI multiplexed with other UCI(s) would be reported on a PUCCH resource outside DRX active time of the DRX group in which this PUCCH is configured, it is up to UE implementation whether to report this CSI multiplexed with other UCI(s).

Regardless of whether the MAC entity is monitoring PDCCH or not on the serving cells in a DRX group, the MAC entity transmits HARQ feedback, aperiodic CSI on PUSCH, and aperiodic SRS defined in TS 38.214 on the serving cells in the DRX group when such is expected.

The MAC entity needs not to monitor the PDCCH if it is not a complete PDCCH occasion (e.g., the active time starts or ends in the middle of a PDCCH occasion).

Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management is supported in NR sidelink transmissions.

To enable the above enhancements, new physical channels and reference signals are introduced in NR (available in LTE before.):
PSSCH (Physical Sidelink Shared Channel, SL version of PDSCH): The PSSCH is transmitted by a sidelink transmitter UE, which conveys sidelink transmission data, system information blocks (SIB s) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PRoSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, the transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, the transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

UE energy saving is one important performance indicator. There is no energy saving feature defined for Sidelink until 3GPP Rel-16. In the 3GPP Rel-17 work item on NR sidelink enhancement, the below objective on UE Sidelink energy saving has been agreed and will be studied in 3GPP Rel-17 time frame—Sidelink DRX for broadcast, groupcast, and unicast:
1) Define on- and off-durations in sidelink and specify the corresponding UE procedure,
2) Specify mechanism aiming to align sidelink DRX wake-up time among the UEs communicating with each other,
3) Specify mechanism aiming to align sidelink DRX wake-up time with Uu DRX wake-up time in an in-coverage UE.

From the above study objectives, DRX mechanisms for Sidelink will be designed and specified in 3GPP Rel-17.

The second objective is one important aspect. A MAC CE may be used for such an objective. In addition, the design for SL needs to preferably consider the below intentions:
1) The MAC CE needs to give best flexibility
2) The MAC CE needs to give lowest signaling overhead
3) Control of the MAC CE for a UE is left to gNB if feasible (e.g., the UE has Uu coverage)
4) The MAC CE is able to achieve alignment of Uu DRX and SL DRX
5) The MAC CE is able to align SL DRX among UEs.

Accordingly, it is at least an object of particular embodiments to solve at least one of the above mentioned problems or achieve at least one of the above mentioned objectives.

Environments where embodiments of the present disclosure may apply involve wireless communication networks, such as fourth-generation (4G) wireless communication networks, new radio networks such as fifth-generation (5G) wireless communication networks. Entities involved in the embodiments of the present disclosure are entities of the wireless communication networks.

Though embodiments of the description are described mainly in the context of a 5G network, it is noted that embodiments of the present disclosure are not limited to the 5G network but are applicable to numerous kinds of networks as appropriate.

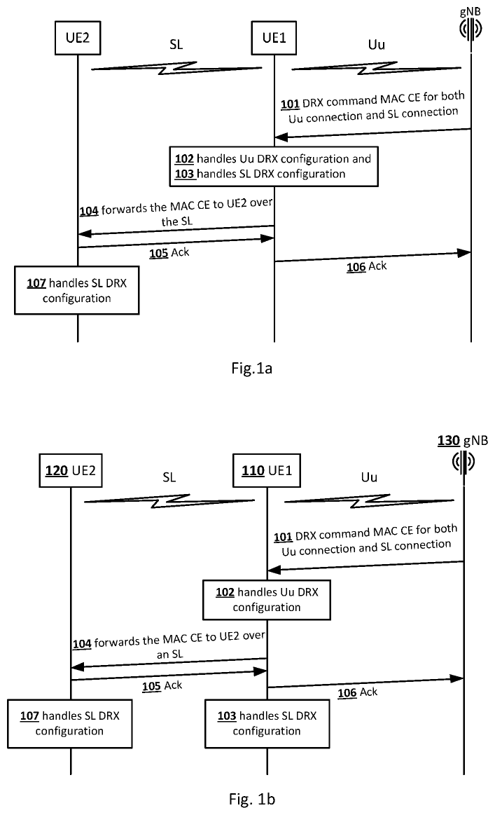

The scenarios illustrated in FIG. 1a-1b comprises a first UE (UE1) served by a first cell (cell1). The UE1 is further configured to communicate with at least one another UE, a second UE (UE2) on sidelink resources. UE1 and UE2 are capable of SL operation. Examples of SL operation are transmission of SL signals by UE1, reception of SL signals at UE1 from UE2 etc.

To enable UL and SL operations, UE1 is further configured with one or more sidelink (SL) resources and one or more uplink resources. At least one of the SL resource can be a SL time resource and also at least one of the UL resource can be an UL time resource. Examples of time resources are symbol, slot, subframe, frame etc. The UE transmits uplink signals on one or more UL resources to at least cell1 i.e., to the serving cell. The UE transmits and/or receive SL signals on one or more SL resources to/from at least UE2. Examples of UL signals are SRS, DMRS, PUCCH, PUSCH, RACH etc. Examples of SL signals are DMRS, PSCCH, PSSCH, PSFCH etc.

The term time resource used herein may correspond to any type of physical resource or radio resource expressed in terms of length of time. Examples of time resources are: symbol, time slot, subframe, radio frame, transmission time interval (TTI), interleaving time, etc. The term TTI used herein may correspond to any time period over which a physical channel can be encoded and optionally interleaved for transmission. The physical channel is decoded by the receiver over the same time period over which it was encoded. The TTI may also interchangeably be referred to as short TTI (sTTI), transmission time, slot, sub-slot, mini-slot, mini-subframe etc.

The term time-frequency resource used herein for any radio resource defined in any time-frequency resource grid in a radio interface. Examples of time-frequency resource are resource block, subcarrier, resource block (RB) etc. The RB may also be interchangeably referred to as physical RB (PRB), virtual RB (VRB) etc.

The link or radio link over which the signals are transmitted between at least two UEs for D2D operation is called herein as the side link (SL). The signals transmitted between the UEs for D2D operation are referred to herein as SL signals. The term SL may also interchangeably be referred to as D2D link, V2X link, prose link, peer-to-peer link, PC5 link etc. The SL signals may also interchangeably be referred to as V2X signals, D2D signals, prose signals, PC5 signals, peer-to-peer signals etc.

Embodiments are applicable to a first UE (UE1) with both UL and SL operations. UE1 connects to at least a second UE (UE2) via an SL. UE1 is configured with both Uu DRX and

SL DRX. UE2 is configured with SL DRX may also be configured with Uu DRX.

Herein, the wording “at least one of” is used in the description of signaling alternatives between two nodes (i.e., between two UEs, or between a gNB and a UE). This wording means that a node may transmit the signaling information to another node using one or more than one alternatives. For the latter case, the node applies several different signaling alternatives to transmit the same information to the other node to improve the transmission reliability.

As shown in FIG. 1a, at step 101, gNB transmits a DRX command MAC CE for both Uu connection between UE1 110 and gNB 130, and at least one SL connection involving UE1 110.

Then at step 102, UE1 110 handles Uu DRX configuration and at step 103 handles at least one SL DRX configuration based on the DRX command MAC CE.

Then at step 104, UE1 110 forwards the DRX command MAC CE to UE2 120 over an SL between UE1 110 and UE2 120.

Then UE2 120 acknowledges the DRX command MAC CE at step 105 with an acknowledgement and handles SL DRX configuration for UE2 based on the DRX command MAC CE.

In response to receiving the acknowledgement, UE1 110 at step 106 acknowledges the gNB that it has notified UE2 120 of at least the SL DRX configuration.

At step 107, UE2 handles SL DRX configuration.

It is noted that unless otherwise indicated (e.g., “then”), embodiments of the present application in the description are not limited to the sequence described in the description or the figures but can be adapted as appropriate instead. For example, steps 102 and 103 can be performed simultaneously or one by one, steps 105 and 107 can be performed simultaneously, or step 105 can be performed after step 107.

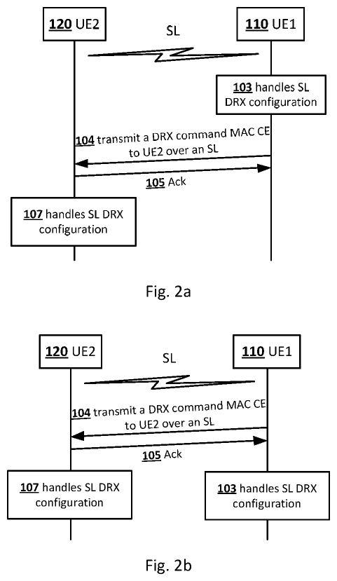

Details of the DRX command MAC CE, and handling of the DRX configuration may be found in description of the first message, the second message, and performing the controlling DRX status below. FIGS. 1a, 1b, 2a and 2b mainly aim to provide a scenario of embodiments of the present application.

FIG. 1b illustrates an alternative of FIG. 1a, where steps with the same reference numbers are the same as those described in FIG. 1a, except that step 103 is performed after step 104. In this way, it is possible that SL DRX configuration at UE1 110 and UE2 120 may be performed at the same time, for example, a specific timer predetermined by UE1 110 and UE2 120 together may be set right after UE 1 has performed step 104, considering time taken by step 104. Then right after the specific timer is expired, UE1 110 performs step 103, and just at that moment, UE2 has received the DRX command MAC CE and starts performing step 107.

Similarly, sequence of steps may be adapted as appropriate unless otherwise indicated. For example, steps 105 and 106 may be adapted to be performed after step 107 and 103 respectively.

It is noted that in step 104 in FIGS. 1a and 1b, the DRX command MAC CE may not be forwarded directly, but sent in another type of signaling (not shown), and thus it is possible that only information related to UE2 is included in the signaling, for example, only information related to SL DRX configuration for UE2 is included, without any information related to Uu DRX configuration for UE1.

It is also noted that the DRX command MAC CE sent from gNB 130 to UE1 may comprise information for SL connection only (not shown). In this case, step 102 can be omitted.

FIGS. 2a and 2b illustrates alternatives of FIGS. 1a and 1b, where no gNB is involved.

In FIG. 2a, at step 103, UE1 110 may handle SL DRX configuration initiated by itself, and transmit a DRX command MAC CE comprising information of SL DRX configuration for UE2 to UE2 120 over an SL between UE1 110 and UE2 120. Then UE2 120 acknowledges the DRX command MAC CE at step 105 with an acknowledgement and handles SL DRX configuration for UE2 based on the DRX command MAC CE at step 107.

FIG. 2b illustrates an alternative of FIG. 2a, where steps with the same reference numbers are the same as those described in FIG. 2a, except that step 103 is performed after step 104. In this way, it is possible that SL DRX configuration at UE1 110 and UE2 120 may be performed at the same time, for example, a specific timer predetermined by UE1 110 and UE2 120 together may be set right after UE 1 has performed step 104, considering time taken by step 104. Then right after the specific timer is expired, UE1 110 performs step 103, and just at that moment, UE2 has received the DRX command MAC CE and starts performing step 107.

Similarly, sequence of steps may be adapted as appropriate unless otherwise indicated. For example, steps 105 may be adapted to be performed after step 107.

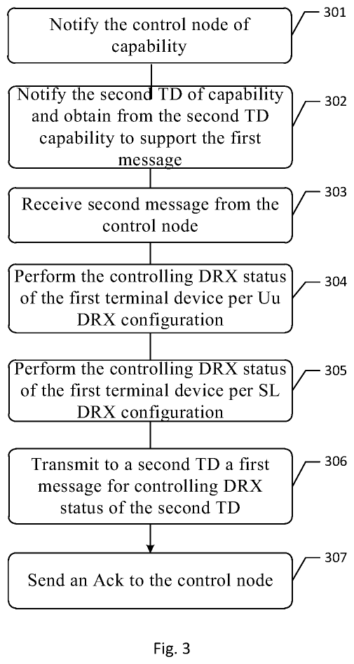

FIG. 3 illustrates a flow chart for a first terminal device (for example, UE1 110 in FIGS. 1a, 1b, 2a and 2b) according to embodiments of the present disclosure. The method comprise a step 306, where the first terminal device transmits, over a sidelink, to a second terminal device (for example, UE2 120 in FIGS. 1a, 1b, 2a and 2b), a first message for controlling DRX status of the second terminal device.

In an example, the step 306 is in response to receiving a second message, from a control node (for example gNB 130 in FIGS. 1a, 1b, 2a and 2b), for controlling DRX status related to the first terminal device and/or both the first terminal device and the second terminal device. For example, the method further comprises step 303, where the second message from the control node is received at the first terminal node.

Then at step 304, the first terminal device performs the controlling DRX status related to the first terminal device per at least one Uu DRX configuration, and at step 305, the first terminal device performs the controlling DRX status related to the first terminal device per at least one sidelink DRX configuration.

It is noted that step 304-306 may be performed at any sequence or at the same time.

Then the first terminal may receive from the second terminal device, an acknowledgement for the first message, it then sends at step 307, to the control node, an acknowledgement for notifying the second terminal device of at least part of the second message.

In this example, step 306 may be simply a forwarding of the second message. Additionally or alternatively, the first message is of a type different from that of the second message and comprises at least part of information in the second message that is related to the second terminal device. Additionally or alternatively, the first message is of a type different from that of the second message and comprises at least part of information that is related to the second terminal device generated according to the information received from the second message.

As the first terminal device may generate a first message by itself without simply forwarding the one from the control node, the information in the generated first message may also be generated by the first terminal device itself according to the information of the second message received from the control node, for instance, the first terminal device is aware that which SL DRX configurations of the second terminal device are associated with the first terminal device. Based on the information of SL DRX configuration of first terminal device indicated in the second message sent by the control node, the first terminal device generates the first message including the information of SL DRX configurations of the second terminal device.

In an example, the step 306 is simply initiated by the first terminal device itself.

In an example, the controlling DRX status related to the second terminal device involves changing DRX active period of the second terminal device.

In an example, the controlling DRX status comprises any one or more of the following: terminating current active period before current running timer is expired, switching from a long active cycle to a short active cycle in case that current active cycle is a long active cycle, or switching from a short active cycle to a long active cycle in case that current active cycle is a short active cycle.

In an example, the first message comprises a MAC CE (for example, DRX command MAC CE), and in an example, the second message comprises a MAC CE (for example, DRX command MAC CE).

In an example, the DRX status related to the first terminal device comprises any one or more of the following: DRX status related to the first terminal device per at least one Uu DRX configuration, or DRX status related to the first terminal device per at least one sidelink DRX configuration.

In an example, the second message comprises at least one indicator indicating any one or more of the following that the controlling DRX status related to the first terminal device is applied to: a Uu connection between the first terminal device and the control node, at least one sidelink connection involving the first terminal device, at least one Uu DRX configuration for the first terminal device, or at least one sidelink DRX configuration for the first terminal device. The at least one indicator may be carried in any one or more of the following: subheader of the second message, payload of the second message, bits in a bitmap field of the second message or logical channel identity of the second message.

In an example, the second message is allocated one of at least one specific logical channel identity, each of the at least one specific logical channel identity indicating any one or more of the following: format of the second message, purpose of the second message, or action of the controlling DRX status.

In an example, the DRX status related to the second terminal device comprises any one or more of the following: DRX status related to the second terminal device per at least one sidelink DRX configuration.

In an example, wherein the first message comprises at least one indicator indicating any one or more of the following that the controlling DRX status related to the second terminal device is applied to: at least one sidelink connection between the first terminal device and the second terminal device, or at least one sidelink DRX configuration for the second terminal. The at least one indicator may be carried in any one or more of the following: subheader of the first message, payload of the first message, bits in a bitmap field of the first message or logical channel identity of the first message.

In an example, the first message is allocated one of at least one specific logical channel identity, each of the at least one specific logical channel identity indicating any one or more of the following: format of the first message, purpose of the first message, or action of the controlling DRX status.

In an example, the at least one indicator in the first message or in the second message may be carried in a reserved field or an existing field in the subheader where the existing field is repurposed.

In an example, each bit in the bitmap of the second message indicates any of the following: the Uu connection between the first terminal device and the control node, one of the at least one sidelink connection involving the first terminal device, one of the at least one Uu DRX configuration for the first terminal device, or one of the at least one sidelink DRX configuration for the first terminal device.

In an example, each bit in the bitmap of the first message indicates any of the following: one of the at least one sidelink connection between the first terminal device and the second terminal device, or one of the at least one sidelink DRX configuration for the second terminal.

It is noted that the indicators described herein may comprise indices of DRX configurations, and Uu DRX configuration and SL DRX configuration may share a same index set.

It is also noted that the network and the UE should have a common understanding on the mapping between DRX configuration indices and connections (e.g., ID of two UEs connecting to each other over SL), which could be known by exchanging (e.g., RRC) signaling in advance.

In an example, the method may further comprise step 301 where the first terminal device notifies the second terminal device of capability of the first terminal device to support the first message and obtaining from the second terminal device capability of the second terminal device to support the first message, via a predefined bit in a message.

In an example, the method may further comprise step 302 where the first terminal device notifies the control node of capability of the first terminal device to support the second message, via a predefined bit in a message.

It is well understood that without the notifying step 301-302, the embodiments of the present disclosure may still work, probably on a pre-determined basis between at least two corresponding nodes.

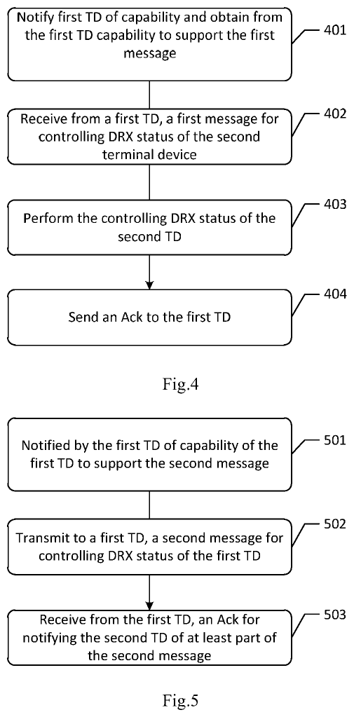

FIG. 4 illustrates a flow chart for a second terminal device according to embodiments of the present disclosure. The method comprises step 402. Where the second terminal device receives, over a sidelink, from the first terminal device described in FIG. 3, the first message for controlling DRX status related to the second terminal device. The terms described with reference to FIG. 4, for example, controlling DRX status related to the second terminal device, the first message, have the same meaning as in description with reference to FIG. 3 and will not be iterated here.

In an example, at step 403, the second terminal device performs the controlling DRX status related to the second terminal device per at least one SL DRX configuration.

In an example, at step 404, the second terminal device sends, to the first terminal device, an acknowledgement for the first message.

It is noted that step 403-404 may be performed at any sequence or at the same time.

In an example, at step 401, the second terminal device notifies the first terminal device capability of the second terminal device to support the first message and obtaining from the first terminal device capability of the first terminal device to support the first message, via a predefined bit indicating the capability in a message. It is well understood that without the notifying step 401, the embodiments of the present disclosure may still work, probably on a pre-determined basis between the first terminal device and the second terminal device.

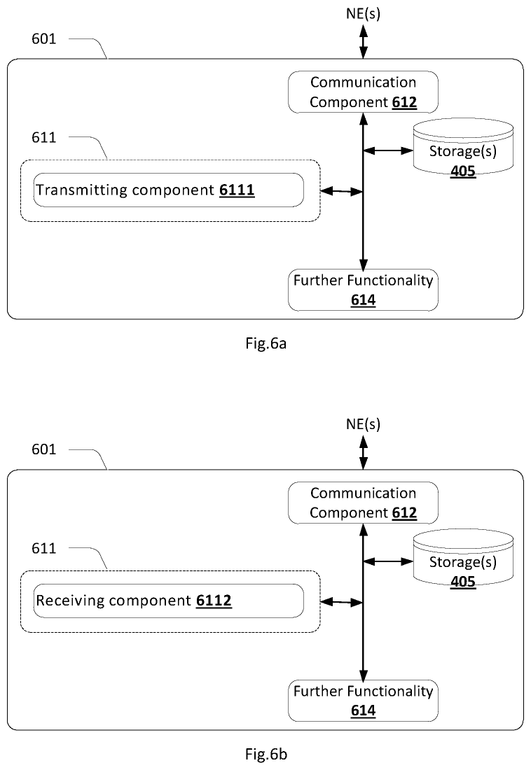

FIG. 5 illustrates a flow chart for a control node according to embodiments of the present disclosure. The method comprise step 502, where the control node transmit, to the first terminal device, the second message for controlling DRX status related to the first terminal device and/or both the first terminal device and the second terminal device. The terms described with reference to FIG. 5, for example, controlling DRX status related to the first terminal device, the second message, have the same meaning as in description with reference to FIG. 3 and will not be iterated here.

In an example, at step 503, the control node may receive, from the first terminal device, an acknowledgement for notifying the second terminal device of at least part of the second message.

In an example, at step 501, the control node may be notified by the first terminal device of capability of the first terminal device to support the second message via a predefined bit in a message. It is well understood that without the notifying step 501, the embodiments of the present disclosure may still work, probably on a pre-determined basis between the first terminal device and the control node.

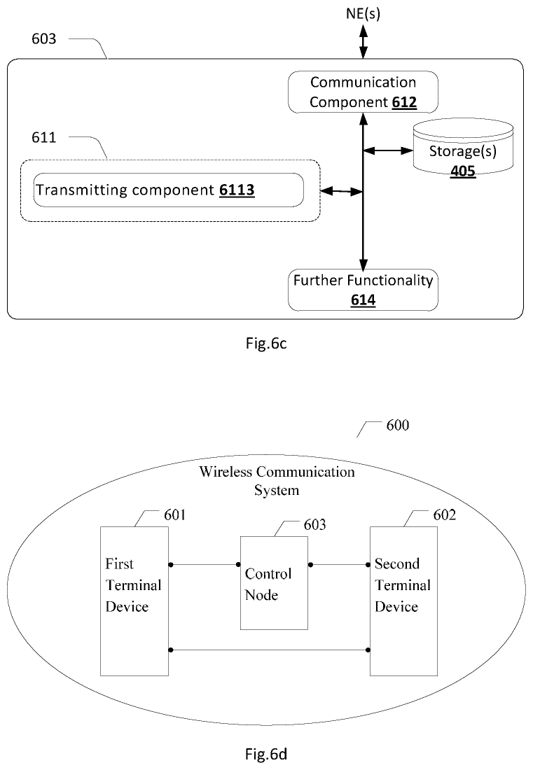

FIG. 6a illustrates a schematic block diagram of a first terminal device according to embodiments of the present disclosure.

The first terminal 601 may be a UE in a next generation network such as a 5G network, a next generation network in combination with a legacy network, or any other appropriate network.

The part of the first terminal 601 which is most affected by the adaptation of the herein described method, e.g., a part of the method described with reference to FIGS. 1a, 1b, 2a, 2b and FIG. 3, is illustrated as an arrangement 611, surrounded by a dashed line. The first terminal 601 and arrangement 611 may be further configured to communicate with other network entities (NE) such as the second terminal or the control node via a communication component 612 which may also be regarded as part of the arrangement 611 (not shown). The communication component 612 comprises means for communication. The arrangement 611 or the first terminal 601 may further comprise a further functionality 614, such as functional components providing regular edge computing functions, and may further comprise one or more storage(s) 405.

The arrangement 611 could be implemented, e.g., by one or more of: a processor or a microprocessor and adequate software and storage for storing of the software, a Programmable Logic Device (PLD) or other electronic component (s) or processing circuitry configured to perform the actions described above, and illustrated, e.g., in FIGS. 1a, 1b, 2a and 2b and 3. The arrangement 611 of the first terminal 601 may be implemented and/or described as follows.

Referring to FIG. 6a, the first terminal 601 may comprise a transmitting component 6111, configured to transmit, over a sidelink, to a second terminal device, a first message for controlling DRX status related to the second terminal device. Details of the action may be found in step 306 as described above and will not be iterated herein.

FIG. 6b illustrates a schematic block diagram of a second terminal device according to embodiments of the present disclosure.

The second terminal 602 may be a UE in a next generation network such as a 5G network, a next generation network in combination with a legacy network, or any other appropriate network.

The part of the second terminal 602 which is most affected by the adaptation of the herein described method, e.g., a part of the method described with reference to FIGS. 1a, 1b, 2a, 2b and FIG. 4, is illustrated as an arrangement 611, surrounded by a dashed line. The second terminal 602 and arrangement 611 may be further configured to communicate with other network entities (NE) such as the first terminal or the control node via a communication component 612 which may also be regarded as part of the arrangement 611 (not shown). The communication component 612 comprises means for communication. The arrangement 611 or the second terminal 602 may further comprise a further functionality 614, such as functional components providing regular edge computing functions, and may further comprise one or more storage(s) 405.

The arrangement 611 could be implemented, e.g., by one or more of: a processor or a microprocessor and adequate software and storage for storing of the software, a Programmable Logic Device (PLD) or other electronic component (s) or processing circuitry configured to perform the actions described above, and illustrated, e.g., in FIGS. 1a, 1b, 2a and 2b and 4. The arrangement 611 of the second terminal 602 may be implemented and/or described as follows.

Referring to FIG. 6b, the second terminal 602 may comprise a receiving component 6112, configured to receive, over a sidelink, from the first terminal device, the first message for controlling DRX status related to the second terminal device. Details of the action may be found in step 402 as described above and will not be iterated herein.

FIG. 6c illustrates a schematic block diagram of a control node according to embodiments of the present disclosure.

The control node 603 may be a UE in a next generation network such as a 5G network, a next generation network in combination with a legacy network, or any other appropriate network.

The part of the control node 603 which is most affected by the adaptation of the herein described method, e.g., a part of the method described with reference to FIGS. 1a, 1b, 2a, 2b and FIG. 5, is illustrated as an arrangement 611, surrounded by a dashed line. The control node 603 and arrangement 611 may be further configured to communicate with other network entities (NE) such as the first terminal device or the second terminal device via a communication component 612 which may also be regarded as part of the arrangement 611 (not shown). The communication component 612 comprises means for communication. The arrangement 611 or the control node 603 may further comprise a further functionality 614, such as functional components providing regular edge computing functions, and may further comprise one or more storage(s) 405.

The arrangement 611 could be implemented, e.g., by one or more of: a processor or a microprocessor and adequate software and storage for storing of the software, a Programmable Logic Device (PLD) or other electronic component (s) or processing circuitry configured to perform the actions described above, and illustrated, e.g., in FIGS. 1a, 1b, 2a and 2b and 4. The arrangement 611 of the control node 603 may be implemented and/or described as follows.

Referring to FIG. 6c, the control node 603 may comprise a transmitting component 6113, configured to transmit, to a first terminal device, the second message for controlling DRX status related to the first terminal device and/or both the first terminal device and the second terminal device. Details of the action may be found in step 502 as described above and will not be iterated herein.

FIG. 6d is a block diagram illustrating a wireless communication system 600 according to some embodiments of the present disclosure. The wireless communication system 600 comprises at least a first terminal device 601, a control node 603 and a second terminal device 602, as depicted in FIGS. 6a, 6b an d6c. In one embodiment, the first terminal device 601, the control node 602 and the second terminal device 603 may communicate with each other.

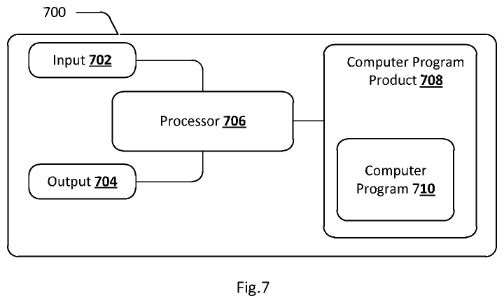

FIG. 7 schematically shows an embodiment of an arrangement 700 which may be used in the first terminal 601, the second terminal 602 or the control node 603. Comprised in the arrangement 700 are here a processor 706, e.g., with a Digital Signal Processor (DSP). The processor 706 may be a single unit or a plurality of units to perform different actions of procedures described herein. The arrangement 700 may also comprise an input unit 702 for receiving signals from other entities, and an output unit 704 for providing signal(s) to other entities. The input unit and the output unit may be arranged as an integrated network element, or a hardware component such as a sensing component.

Furthermore, the arrangement 700 comprises at least one computer program product 708 in the form of a non-volatile or volatile storage, e.g., an Electrically Erasable Programmable Read-Only Memory (EEPROM), a flash memory and a hard drive, and those from a network or a cloud connected via the input unit 702 and output unit 704. The computer program product 708 comprises a computer program 710, which comprises code/computer readable instructions, which when executed by the processor 706 in the arrangement 700 causes the arrangement 700 and/or the first terminal 601 or the agent in which it is comprised to perform the actions, e.g., of the procedure described earlier in conjunction with FIGS. 1a, 1b, 2a, 2b, and 3-5.

The computer program 710 may be configured as a computer program code structured in computer program modules. Hence, in an exemplifying embodiment when the arrangement 700 is used in the first terminal 601, the code in the computer program of the arrangement 700 when executed, will cause the processor 706 to perform the steps as described with reference to FIGS. 1a, 1b, 2a, 2b, and 3-5.

The processor 706 may be a single Central Processing Unit (CPU) but could also comprise two or more processing units. For example, the processor 706 may include general purpose microprocessors, instruction set processors and/or related chip sets and/or special purpose microprocessors such as Application Specific Integrated Circuits (ASIC). The processor 706 may also comprise board memory for caching purposes. The computer program 710 may be carried by a computer program product 708 connected to the processor 706. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories. The computer program product may also comprise an electronic signal, optical signal, or radio signal, etc. in which the computer program is transmitted.

As a whole or by scenario, by adapting DRX active period, power consumption may be saved when traffic is low and latency may be improved when traffic is high, and thus a good tradeoff between UE power consumption and the performance of SL transmissions can be achieved. Compared to RRC, signaling overhead of MAC CE is very small. Active time on the SL can be aligned between a transmitting UE a receiving UE. In this way, data loss due to active time misalignment can be minimized.

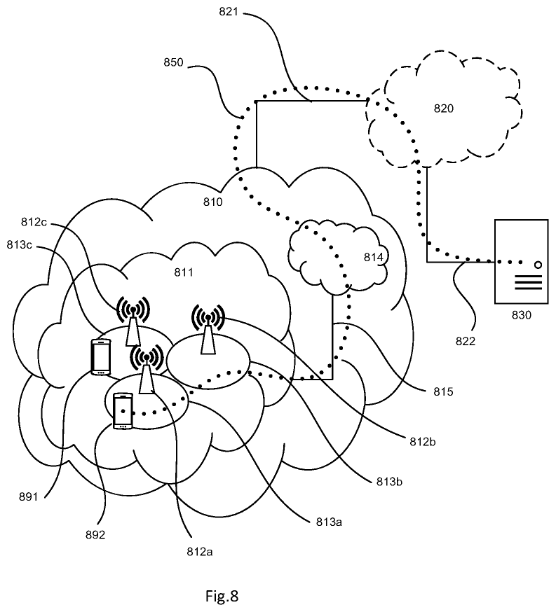

With reference to FIG. 8, in accordance with an embodiment, a communication system includes a telecommunication network 810, such as a 3GPP-type cellular network, which comprises an access network 100 of FIG. 1, such as a radio access network, and a core network 814. The access network 100 comprises a plurality of base stations 110 A, 110 B, 110 C, such as NB s, eNBs, gNBs or other types of wireless access points, each defining a corresponding coverage area 102, 104,106. Each base station 110 A, 110 B, 110 C is connectable to the core network 814 over a wired or wireless connection 815. A first user equipment (UE) 120 A located in coverage area 106 is configured to wirelessly connect to, or be paged by, the corresponding base station 110 C. A second UE 110 B in coverage area 102 is wirelessly connectable to the corresponding base station 110 A. While a plurality of UEs 120 A, 120 B are illustrated in this example, the disclosed embodiments are equally applicable to a situation where a sole UE is in the coverage area or where a sole UE is connecting to the corresponding base station 110.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between one of the connected UEs 120 A, 120 B and the host computer 830. The connectivity may be described as an over-the-top (OTT) connection 850. The host computer 830 and the connected UEs 120 A, 120 B are configured to communicate data and/or signaling via the OTT connection 850, using the access network 100, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 110 may not or need not be informed about the past routing of an incoming downlink communication with data originating from a host computer 830 to be forwarded (e.g., handed over) to a connected UE 120. Similarly, the base station 110 need not be aware of the future routing of an outgoing uplink communication originating from the UE 120 towards the host computer 830.

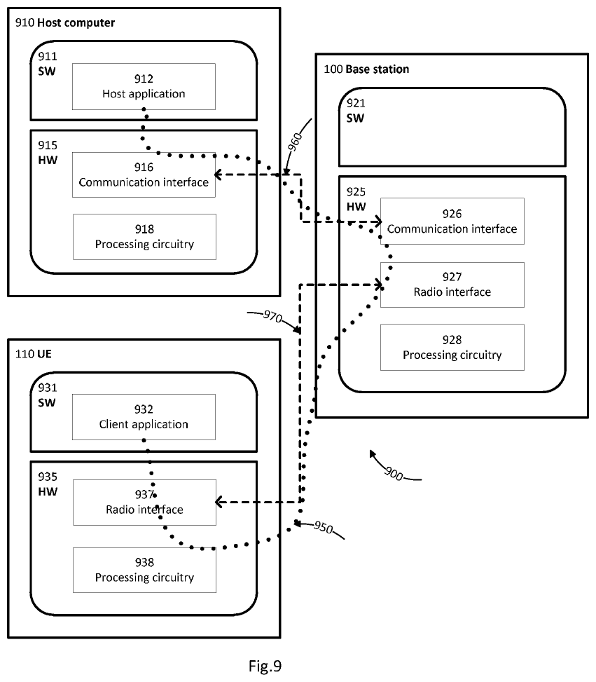

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection. The communication system 900 further includes the UE 930 already referred to. Its hardware 935 may include a radio interface 912 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 110 A, 110 B, 110 C and one of the UEs 120 A, 120 B of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the use equipment 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may increase access rate due to support of RA procedure across cells/carriers to gain additional RA opportunities, and also due to improved cell configuration from indication of RA events. Thereby benefits such as reduced user waiting time and better responsiveness are provided.

A measurement procedure may be provided for the purpose of monitoring data rate, latency and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or ‘dummy’ messages, using the OTT connection 950 while it monitors propagation times, errors etc.

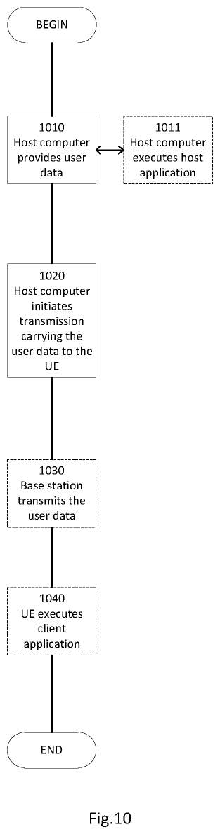

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

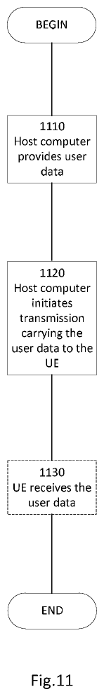

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

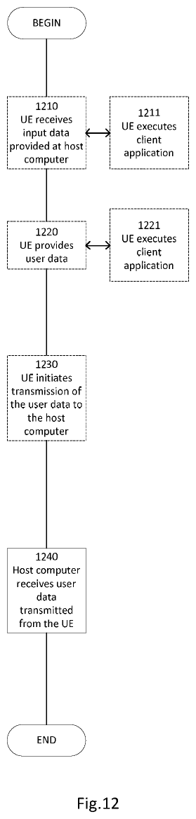

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 1210 of the method, the UE receives input data provided by the host computer. Additionally or alternatively, in an optional second step 1220, the UE provides user data. In an optional substep 1221 of the second step 1220, the UE provides the user data by executing a client application. In a further optional substep 1211 of the first step 1210, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1230, transmission of the user data to the host computer. In a fourth step 1010 of the method, the host computer receives the user data transmitted from the UE, in accordance with the teachings of the embodiments described throughout this disclosure.

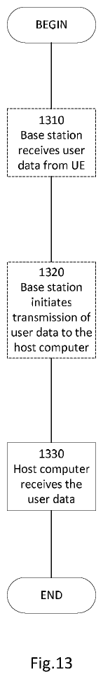

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 1310 of the method, in accordance with the teachings of the embodiments described throughout this disclosure, the base station receives user data from the UE. In an optional second step 1320, the base station initiates transmission of the received user data to the host computer. In a third step 1330, the host computer receives the user data carried in the transmission initiated by the base station.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore, it is intended that the present embodiments not be limited to the particular embodiment disclosed as the best mode contemplated for carrying out the present technology, but that the present embodiments include all embodiments falling within the scope of the appended claims.

1. A method implemented by a first terminal device, the method comprising:
transmitting over a sidelink, to a second terminal device, a first message for controlling discontinuous reception, DRX, status of the second terminal device.

2. The method of claim 1, wherein the transmitting is in response to receiving a second message, from a control node, for controlling DRX status related to at least one of the first terminal device and both the first terminal device and the second terminal device.

3. The method of claim 1, wherein the transmitting is initiated by the first terminal device.

4. The method of claim 1, wherein the controlling DRX status related to the second terminal device involves changing DRX active period of the second terminal device.

5. The method of claim 1, wherein the controlling DRX status comprises any one or more of the following:
terminating current active period before current running timer is expired,
switching from a long active cycle to a short active cycle in case that current active cycle is a long active cycle, or
switching from a short active cycle to a long active cycle in case that current active cycle is a short active cycle.

6. The method of claim 1, wherein the first message comprises a Media Access Control, MAC, Control Element, CE.

7. The method of claim 2, wherein the second message comprises a Media Access Control, MAC, Control Element, CE.

8. The method of claim 2, wherein the DRX status related to the first terminal device comprises any one or more of the following: DRX status related to the first terminal device per at least one Uu DRX configuration, and DRX status related to the first terminal device and the second terminal device per at least one sidelink DRX configuration.

9. The method of claim 2, wherein the second message comprises at least one indicator indicating any one or more of the following that the controlling DRX status related to the first terminal device is applied to: a Uu connection between the first terminal device and the control node, at least one sidelink connection involving the first terminal device, at least one Uu DRX configuration for the first terminal device, or at least one sidelink DRX configuration for the first terminal device.

10. The method of claim 9, wherein the at least one indicator is carried in any one or more of the following: subheader of the second message, payload of the second message, bits in a bitmap field of the second message or logical channel identity of the second message.

11. The method of claim 2, wherein the second message is allocated one of at least one specific logical channel identity, each of the at least one specific logical channel identity indicating any one or more of the following: format of the second message, purpose of the second message, or action of the controlling DRX status.

12.-25. (canceled)

26. A method implemented by a second terminal device, the method comprising:
receiving, over a sidelink, from a first terminal device, a first message for controlling Discontinuous Reception, DRX, status of the second terminal device.

27.-38. (canceled)

39. A method implemented by a control node, the method comprising:
transmitting, to a first terminal device, a second message for controlling Discontinuous Reception, DRX, status of at least one of the first terminal device and both the first terminal device and the second terminal device.

40. The method of claim 39, wherein the controlling DRX status comprises any one or more of the following:
terminating current active period before current running timer is expired,
switching from a long active cycle to a short active cycle in case that current active cycle is a long active cycle, or
switching from a short active cycle to a long active cycle in case that current active cycle is a short active cycle.

41. The method of claim 39, wherein the second message comprises a Media Access Control, MAC, Control Element, CE.

42. The method of claim 39, wherein the DRX status related to the first terminal device comprises any one or more of the following: DRX status related to the first terminal device per at least one Uu DRX configuration, or DRX status related to the first terminal device and the second terminal device per at least one sidelink DRX configuration.

43. The method of claim 39, wherein the second message comprises at least one indicator indicating any one or more of the following that the controlling DRX status related to the first terminal device is applied to: a Uu connection between the first terminal device and the control node, at least one sidelink connection involving the first terminal device, at least one Uu DRX configuration for the first terminal device, or at least one sidelink DRX configuration for the first terminal device.

44. The method of claim 43, wherein the at least one indicator is carried in any one or more of the following: subheader of the second message, payload of the second message, bits in a bitmap field of the second message or logical channel identity of the second message.

45. The method of claim 39, wherein the second message is allocated one of at least one specific logical channel identity, each of the at least one specific logical channel identity indicating any one or more of the following: format of the second message, purpose of the second message, or action of the controlling DRX status.

46. The method of claim 39, further comprising:
receiving, from the first terminal device, an acknowledgement for notifying the second terminal device of at least part of the second message.

47. The method of claim 44, wherein the at least one indicator is carried in a reserved field or an existing field in the subheader.

48. The method of claim 44, wherein each bit in the bitmap indicates any of the following: the Uu connection between the first terminal device and the control node, one of the at least one sidelink connection involving the first terminal device, one of the at least one Uu DRX configuration for the first terminal device, or one of the at least one sidelink DRX configuration for the first terminal device.

49. The method of claim 39, further comprising:
being notified by the first terminal device of capability of the first terminal device to support the second message.

50. An apparatus for a first terminal device, comprising:
a transmitting component, configured to transmit, over a sidelink, to a second terminal device, a first message for controlling Discontinuous Reception, DRX, status of the second terminal device.

51.-58. (canceled)
